(19) United States
(12) Patent Application Publication
(10) Pub. No.: US 2011/0179202 A1
(43) Pub. Date: Jul. 21, 2011

(54) METHOD OF STORING DOCUMENT IN DOCUMENT BOX, AND HOST APPARATUS AND IMAGE FORMING APPARATUS TO PERFORM THE METHOD

(75) Inventor: So-young KIM, Suwon-si (KR)

(73) Assignee: Samsung Electronics Co., Ltd., Suwon-si (KR)

(21) Appl. No.: 12/886,794

(22) Filed: Sep. 21, 2010

(30) Foreign Application Priority Data
Jan. 21, 2010 (KR) 10-2010-0005751

(51) Int. Cl. G06F 13/10

(52) U.S. Cl. 710/74

(57) ABSTRACT

A document storing method of a host apparatus connectable to an image forming apparatus to store a document in at least one document box generated in the image forming apparatus, the document storing method includes receiving attribute information to indicate at least one attribute of the document, and controlling the document to be stored in at least one document box corresponding to the at least one attribute indicated by the attribute information according to storage rules that are previously stored.

### CROSS-REFERENCE TO RELATED APPLICATIONS

This application claims priority under 35 U.S.C. §119(a) from Korean Patent Application No. 10-2010-0005751, filed on Jan. 21, 2010, in the Korean Intellectual Property Office, the disclosure of which is incorporated herein in its entirety by reference.

### BACKGROUND

1. Field of the Invention

Exemplary embodiments of the present general inventive concept relate to a method of storing a document in a document box, and a host apparatus and an image forming apparatus to perform the method.

2. Description of the Related Art

An image forming apparatus refers to an office automation machine including a printer to perform one or more functions including a printing operation, a copying operation, a scanning operation, and a facsimile operation; a copying machine; a scanner; a facsimile or the like. Due to a wide variety of apparatuses including the printer, the scanner, the copying machine, and the facsimile, a multi-function product (MFP) made by integrating functions of these apparatuses into one apparatus has been developed and widely used. A storage area including a memory arranged in the image forming apparatus functions as a buffer of data generated while a printing operation is performed. However, recently, an image forming apparatus that stores a document in the storage area has been introduced.

### SUMMARY

The present general inventive concept provides a method of classifying document boxes for storage according to a type of a document, and storing the document in one of the document boxes, and a host apparatus and an image forming apparatus to perform the method.

Additional features and/or utilities of the present general inventive concept will be set forth in part in the description which follows and, in part, will be obvious from the description, or may be learned by practice of the present general inventive concept.

The foregoing and/or other features and utilities of the present general inventive concept may be achieved by providing a document storing method of a host apparatus connectable to an image forming apparatus to store a document in at least one document box generated in the image forming apparatus, the document storing method includes receiving a storage command from the host apparatus to store the document in the image forming apparatus, receiving storage rules stored in the image forming apparatus, and displaying the storage rules on the host apparatus according to the storage command, receiving attribute information to indicate at least one attribute of the document, and controlling the document to be stored in at least one document box corresponding to the at least one indicated attribute according to the storage rules.

The receiving of the storage command may include receiving the storage command by using a user interface of a printer driver driven by the host apparatus, or by using a user interface of an application program.

The storage rules may include a field of the at least one attribute of the document corresponding to the at least one document box, and conditions of the at least one attribute which are defined in the field.

The receiving the storage rules including a field of the at least one attribute of the document corresponding to the at least one document box, and conditions of the at least one attribute which are defined in the field, may occur before receiving the attribute information.

The controlling may include performing a control operation according to a result of checking performed in the image forming apparatus, wherein the control operation may be related to whether the at least one attribute indicated by the attribute information is applied to the storage rules.

When the result of the checking indicates that the at least one attribute indicated by the attribute information is applied to a plurality of conditions comprised in the storage rules, the controlling may include controlling the document to be copied and then stored in each of a plurality of document boxes corresponding to the plurality of conditions.

When the result of the checking indicates that the at least one attribute indicated by the attribute information is not applied to a plurality of conditions comprised in the storage rules, the controlling may include controlling the document to be stored in a default document box.

When the result of the checking indicates that the at least one attribute indicated by the attribute information is applied to a plurality of conditions comprised in the storage rules, the controlling may include controlling the document to be stored according to a priority order set to the plurality of conditions comprised in the storage rules.

The document storage method may further include controlling a new document box to be generated in the image forming apparatus.

The attribute information may indicate a prefix, a printing time of the document, or a file size of the document.

The document storage method may further include displaying a result obtained by storing the document.

The foregoing and/or other features and utilities of the present general inventive concept may be achieved by providing a document storing method performed by an image forming apparatus having at least one document box, the document storing method including the operations of when a storage command to store the document in the image forming apparatus is received from a host apparatus, transmitting storage rules stored in the image forming apparatus, and receiving the document and attribute information to indicate at least one attribute of the document, checking whether the at least one attribute indicated by the attribute information is applied to the storage rules, determining at least one document box corresponding to the at least one attribute indicated by the attribute information according to a result of the checking, and storing the document in the determined at least one document box.

The document storing method may further include receiving a new storage rule comprising a field of the at least one attribute of the document corresponding to the at least one document box, and conditions of the at least one attribute which are defined in the field.

The document storing method may further include generating a new document box in the image forming apparatus.

The foregoing and/or other features or utilities of the present general inventive concept may be achieved by providing a host apparatus connectable to an image forming apparatus to store a document in at least one document box generated in the image forming apparatus, the host apparatus including a user interface unit to receive a storage command to store the document in the image forming apparatus, a network interface unit to receive storage rules stored in the image forming apparatus according to the storage command, an attribute information setting unit to receive attribute information indicating at least one attribute of the document via the user interface unit, and setting the attribute information, and a host controller to control the document to be stored in at least one document box corresponding to the at least one attribute indicated by the attribute information according to the storage rules.

The user interface unit may receive the storage command by using a printer driver driven in the host apparatus, or an application program.

The user interface unit may receive a new storage rule comprising a field of the at least one attribute of the document corresponding to the at least one document box, and conditions of the at least one attribute which are defined in the field.

The foregoing and/or other features or utilities of the present general inventive concept may be achieved by providing an image forming apparatus having at least one document box to store a document, the image forming apparatus including a network interface unit to receive attribute information to indicate at least one attribute of the document, a checking unit to check whether the at least one attribute indicated by the attribute information is applied to storage rules stored in the image forming apparatus, a document box determining unit to determine at least one document box corresponding to the at least one attribute indicated by the attribute information according to a result of the checking, a control unit to control the document to be stored in the determined at least one document box, and a storage unit to store the at least one document box and the storage rules.

The foregoing and/or other features or utilities of the present general inventive concept may also be achieved by providing an image forming apparatus having at least one document box to store a document, the image forming apparatus including a network interface unit to transmit storage rules stored in the image forming apparatus, and receiving the document and attribute information indicating at least one attribute of the document, when a storage command to store the document in the image forming apparatus is received from a host apparatus, a checking unit to check whether the at least one attribute indicated by the attribute information is applied to the storage rules, a document box determining unit to determine at least one document box corresponding to the at least one attribute indicated by the attribute information according to a result of the checking, and a control unit to store the document in the determined at least one document box.

The image forming apparatus may further include an update unit to update the storage rules by adding a new storage rule to the storage rules stored in the image forming apparatus, wherein the new storage rule comprises a field of the at least one attribute of the document corresponding to the at least one document box, and conditions of the at least one attribute which are defined in the field.

The foregoing and/or other features or utilities of the present general inventive concept may also be achieved by providing an image forming apparatus which includes a storage unit to store at least one document box, a network interface unit to transmit a storage rule to an external device and to receive attribute information of a document when the document is requested to be stored, and a controller to store the document in the at least one document box according to the storage rule and the attribute information.

The document may be stored in the at least one document box when the attribute information corresponds with the storage rule.

The image forming apparatus may further include an interface unit to receive the storage rule.

The foregoing and/or other features or utilities of the present general inventive concept may also be achieved by providing a method to store a file in an image forming apparatus which includes receiving a first signal to store the file within a plurality of document boxes of an image forming apparatus from a host apparatus, transmitting a storage rule to the host apparatus, receiving attribute information of the file, and controlling the file to be stored within a document box of the plurality of document boxes which corresponds to the attribute information of the file and the storage rule.

The foregoing and/or other features or utilities of the present general inventive concept may also be achieved by providing a document storage method of an image forming apparatus having a plurality of document boxes, the method includes receiving a signal requesting to store a document, determining whether attribute information of the document corresponds with a storage rule, and controlling the document to be stored in a first document box when the attribute information corresponds with the storage rule or a second document box when the attribute information does not correspond with the storage rule.

The storage rule may be stored within a storage unit of the image forming apparatus.

### BRIEF DESCRIPTION OF THE DRAWINGS

The above and other features and/or utilities of the present general inventive concept will become more apparent by describing in detail exemplary embodiments thereof with reference to the attached drawings in which:

FIG. 1 is a diagram of an image forming system according to an exemplary embodiment of the present general inventive concept;

FIG. 2 is a detailed schematic diagram of configurations of an image forming apparatus and a host apparatus of FIG. 1, according to an exemplary embodiment of the present general inventive concept;

FIG. 3 is a table indicating storage rules according to an exemplary embodiment of the present general inventive concept;

FIG. 4 is a diagram of a case in which information about a store job is input by using a printer driver displayed on a user interface unit according to an exemplary embodiment of the present general inventive concept;

FIG. 5 is a diagram of a case in which a priority order is set to each storage condition included in the storage rule according to an exemplary embodiment of the present general inventive concept;

FIGS. 6A through 6D are diagrams of a case in which a document box is newly generated, and a storage rule is defined for the new document box according to an exemplary embodiment of the present general inventive concept;

FIGS. 7A through 7C are diagrams of a case in which a storage rule is additionally defined in existing document boxes according to an exemplary embodiment of the present general inventive concept;

FIGS. 8A and 8B are diagrams of a user interface unit displaying a result obtained by storing a document in a document box according to an exemplary embodiment of the present general inventive concept;

FIG. 9 is a flowchart of a method to store a document in at least one document box stored in an image forming apparatus according to an exemplary embodiment of the present general inventive concept;

FIG. 10 is a detailed flowchart of the method to store the document of FIG. 9; and

FIG. 11 is a flowchart of a method of setting a new storage rule according to an exemplary embodiment of the present general inventive concept.

### DETAILED DESCRIPTION OF THE EMBODIMENTS

Hereinafter, the present general inventive concept will be described in detail by explaining exemplary embodiments of the present general inventive concept with reference to the attached drawings. Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

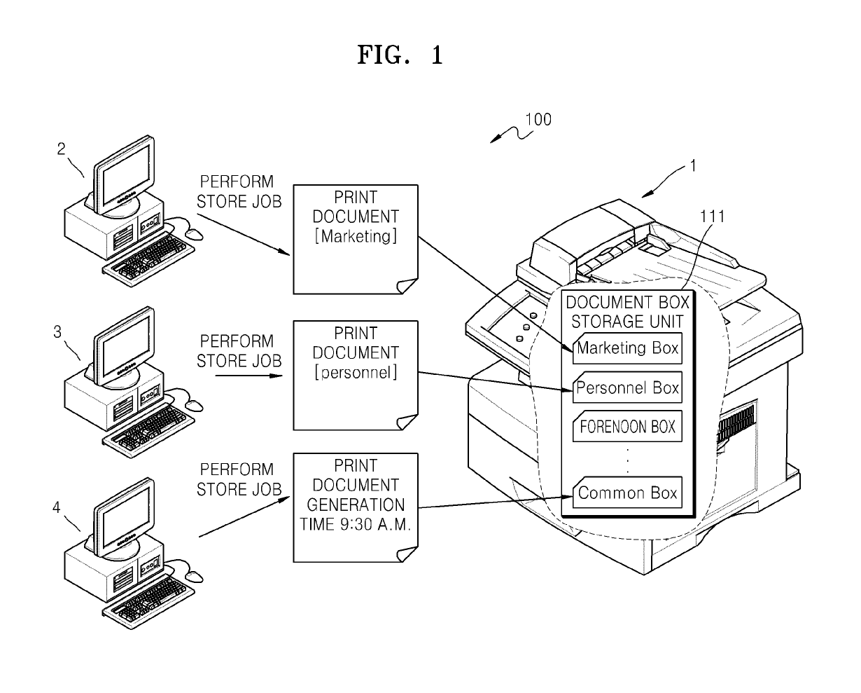

FIG. 1 is a diagram of an image forming system 100 according to an exemplary embodiment of the present general inventive concept. Referring to FIG. 1, the image forming system 100 is configured with an image forming apparatus 1 and a plurality of host apparatuses 2, 3, and 4, which are connected to the image forming apparatus 1 in a network. For convenience of description, the plurality of host apparatuses 2, 3, and 4 are illustrated in FIG. 1, but the image forming apparatus 1 may include only one host apparatus, or may include two or more image forming apparatuses.

The image forming apparatus 1 may include an inkjet printer, a laser printer, a scanner, a multi-function product (MFP), and the like which perform one or more functions including a printing operation, a copying operation, a scanning operation, a faxing operation, and an e-mail transmission.

In exemplary embodiments, the image forming apparatus 1 may include an internal storage space in which a document box storage unit 111 can be stored. The document box storage unit 111 may be formed in such a manner that the storage space in the image forming apparatus 1 is logically classified and then may be displayed in a form of a user interface. A lower layer of the document box storage unit 111 may include detailed document boxes including a marketing box, a personnel box, a forenoon box, a common box, etc. However, the present general inventive concept is not limited thereto. That is, in exemplary embodiments, a user may define custom document boxes to be stored within the document box storage unit 111. Each of the document boxes may store a document file, and a user may search for a particular document box and may retrieve and download a document stored in the particular document box. That is, in exemplary embodiments, each user of the plurality of host apparatuses 2, 3, and 4 may search for a particular document box within the image forming apparatus 1 and may retrieve and/or download a document stored in the particular document box.

In exemplary embodiments, the image forming apparatus 1 may communicate with a plurality of users (i.e., a first user and a second user) via the network. Thus, the first user may access the document box storage unit 111 of the image forming apparatus 1 connected via the network and then may upload a document to one of the document boxes, and the second user connected to the image forming apparatus 1 via the network may access the document box storage unit 111 of the image forming apparatus 1 and then may download the document uploaded by the first user. That is, since the document box storage unit 111 may be shared between the plurality of users connected via the network, a shared document may be directly downloaded to the host apparatuses 2, 3, and 4 or printed with the image forming apparatus 1. Thus, it may be possible to reduce an inconvenience caused by exchanging a document between the host apparatuses 2, 3, and 4 and then printing the document with the image forming apparatus 1.

The document according to the present exemplary embodiment may include not only a paper having information printed thereon but may also include structured user information formed to be readable by a human eye or a machine, or an item that may exchangeable between the plurality of users or between a plurality of image forming systems. Also, the document according to the present exemplary embodiment may include an electronic document recordable on a disc.

To be more specific with respect to the image forming system 100, a user may command a generation of a desired document by using a printer driver of the host apparatus 2. That is, the user may select a print job or a store job, which is a print option to be selected by the user via the printer driver, and may set the selected job, wherein the print job indicates a print command by which the image forming apparatus 1 prints a document via a printing medium, and the store job indicates a storage command by which the document is stored in the document box storage unit 111 of the image forming apparatus 1.

According to a conventional method, when a user selects a store job, a host apparatus receives a list of document boxes of an image forming apparatus from the image forming apparatus, and then displays the received list so as to store a document in a document box storage unit of the image forming apparatus. Then, a user selects one document box within the list of the document boxes displayed on the host apparatus, and stores the document in the selected document box. However, the fact that the list of the document boxes is transmitted from the image forming apparatus to the host apparatus whenever a store job is performed or requested adversely effects performance of both the image forming apparatus and the host apparatus. Also, it may be a problem since it may require a long wait time to transmit and receive the list of the document boxes in a network where a transmission speed is slow.

However, in exemplary embodiments of the present general inventive concept, in order to reduce a performance issue and a required wait time due to transmission and reception of a list of the document boxes, a rule to store a document in at least one of the document boxes according to attributes of the document may be previously set and then the document can be stored in the image forming apparatus 1 of an image forming system. Thus, when a user inputs attribute information indicating at least one attribute of a document to be stored in the document boxes, the document may be automatically stored in one of the document boxes according to a storage rule stored in the image forming apparatus 1, wherein the one document box corresponds to an attribute indicated by the input attribute information of the stored document.

In exemplary embodiments, the image forming apparatus 1 may previously store a storage rule by which, if the attribute of the document indicates [Marketing], the document is stored in the marketing box. If the attribute of the document indicates [Personnel], the document is stored in the personnel box, and if the attribute of the document indicates [Generation time 9:30 a.m.], the document is stored in the forenoon box. When a user inputs [Marketing] as the attribute information indicating the attribute of the document via the host apparatus 2, the document may be automatically stored in the marketing box. When a user inputs [Personnel] as the attribute information indicating the attribute of the document via the host apparatus 3, the document may be automatically stored in the personnel box. Also, when a user inputs [Generation time] as the attribute information indicating the attribute of the document via the host apparatus 2, since the generation time of the document is 9:30 a.m., the document is automatically stored in the forenoon box.

That is, in exemplary embodiments, it is possible to automatically store a document in a desired document box of the image forming apparatus 1 without the user first receiving a list of the document boxes, so that a performance issue and a required wait time may be eliminated or substantially reduced.

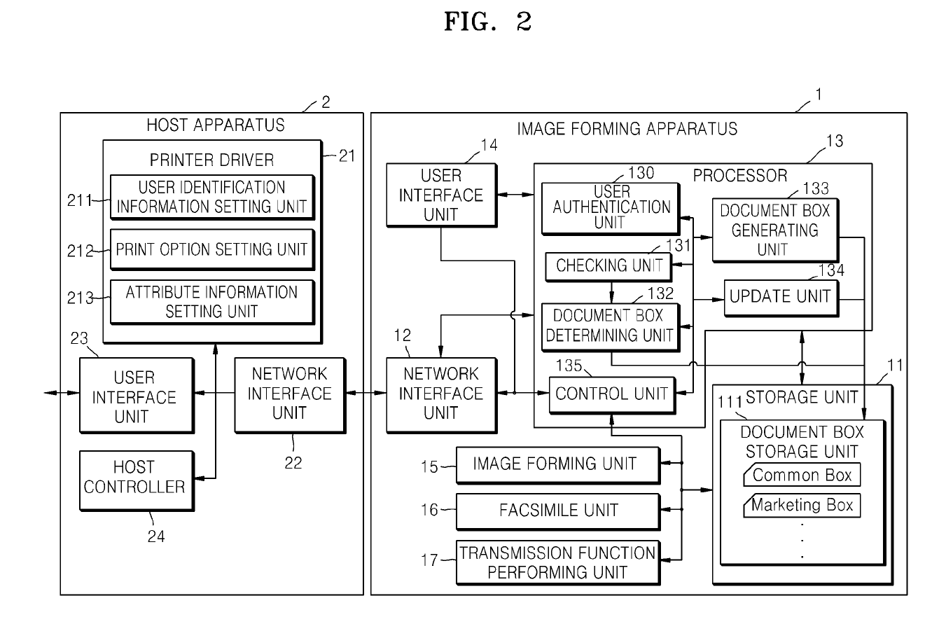

FIG. 2 is a detailed schematic diagram configurations of the image forming apparatus 1 and the host apparatus 2 of FIG. 1. Referring to FIG. 2, the image forming apparatus 1 includes a storage unit 11, a network interface unit 12, a processor 13, a user interface unit 14, an image forming unit 15, a facsimile unit 16, and a transmission function performing unit 17. The processor 13 can include of a user authentication unit 130, a checking unit 131, a document box determining unit 132, a document box generating unit 133, an update unit 134, and a control unit 135. In exemplary embodiments, the processor 13 may be embodied as an array of a plurality of logic gates, or may be embodied as a combination of a general-use microprocessor and a memory having stored therein a program to be executed in a general-use microprocessor. However, the present general inventive concept is not limited thereto. That, in alternative exemplary embodiments, it will be understood by one of ordinary skill in the art that the processor 13 may be embodied as different forms of hardware.

The host apparatus 2 may include a printer driver 21, a network interface unit 22, a user interface unit 23, and a host controller 24. The printer driver 21 may include a user identification information setting unit 211, a print option setting unit 212, and an attribute information setting unit 213.

In the following description, only hardware components that are related to the present exemplary embodiment are described so as to prevent the present exemplary embodiment from being obscured. However, it will be understood by one of ordinary skill in the art that other general-use hardware components, other than the hardware components illustrated in FIG. 1, may also be included in the present exemplary embodiment.

Hereinafter, a method in which a store job is performed so that a document is stored in the document box storage unit 111 will be described in relation to operations of the image forming apparatus 1 and the host apparatus 2. First, operations of configuring components of the host apparatus 2 will be described.

A user may drive the printer driver 21 of the host apparatus 2 so as to perform an operation according to a user's desired print option. As described with reference to FIG. 1, the print option includes the print job and the store job. Hereinafter, from the print option, the store job to store a document in a document box will now be described.

The user interface unit 23 displays information, which is processed by the printer driver 21, to the user of the host apparatus 2. That is, when the printer driver 21 is driven, the user interface unit 23 displays a screen to receive the print option, and attribute information which indicates at least one attribute of the document. Also, in exemplary embodiments, the user interface unit 23 displays storage rules that may be previously stored in the image forming apparatus 1. Then, the user interface unit 23 receives information to drive the printer driver 21 from the user.

To be more specific, in order for the user to perform the store job to store the document in a document box of the document box storage unit 111, the host apparatus 2 is requested by the user for a store job, which is a storage command by which the document is to be stored in the image forming apparatus 1. The user requests the store job by using a user interface of a printer driver or a user interface of an application program, which may be a part of a printer driver driven in the host apparatus 2, via the user interface unit 23. In addition, when the store job is selected, the user interface unit 23 receives attribute information from the user, wherein the attribute information indicates at least one attribute of the document. Also, the user interface unit 23 may receive user identification information of the user in order allow the user to use the image forming apparatus 1.

The print option setting unit 212 sets the print option that is input via the user interface unit 23. That is, when the user selects and inputs the store job by using the user interface unit 23, the print option setting unit 212 sets an operation to be executed so that the document is stored in the document box storage unit 111.

The attribute information setting unit 213 sets the attribute information to indicate at least one attribute of the document, wherein the information is input via the user interface unit 23. The attribute information setting unit 213 performs the setting operation in a case where the store job is input as the print option. Here, the attribute information which indicates at least one attribute of the document corresponds to a field and a condition included in the storage rule. In exemplary embodiments, the attribute information which indicates at least one attribute of the document includes information corresponds to the field included in the storage rule, wherein the field is a prefix to be set in the document, a printing time of the document, or a file size of the document. However, the present general inventive concept is not limited thereto. That is, in alternative exemplary embodiments, the attribute information may include a desired print quality of the document, information indicating whether the document contains images to be printed in color, or a security status of the document. In exemplary embodiments, the security status may indicate whether the document is to be protected and therefore stored in a secured document box, to which access is granted based upon the user identification information. Also, the attribute information indicating at least one attribute of the document may include information corresponding to conditions such as [Marketing], [Personnel], and the like which are included in the storage rule.

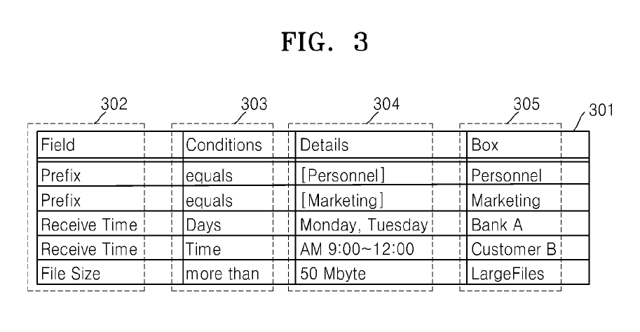

In this regard, a detailed description will be provided with reference to FIG. 3.

FIG. 3 is a table indicating storage rules according to an exemplary embodiment of the present general inventive concept. Referring to FIG. 3, the field of the attribute information of the document, and conditions of the attribute in the field are defined in the storage rule. To be more specific, the storage rule includes a field of an attribute of a document corresponding to a specific document box, and definition and details of conditions of the attribute in the field. The field of the attribute of the document included in the storage rule includes [Prefix], [Generation time], [Generation date], and [Pages] fields. In exemplary embodiments, the [Prefix] field may include definitions or conditions such as [equals], and details such as [Marketing] and [Personnel]. However, the present general inventive concept is not limited thereto.

To be more specific, in a case where attribute information indicating at least one attribute of an input document indicates [Prefix] and [Marketing], the attribute information of the input document indicates a store job by which the document is to be stored in the marketing box of the document box storage unit 111. Also, in a case where attribute information indicating at least one attribute of the input document indicates [Prefix] and [Personnel], the attribute information indicates a store job by which the document is stored in the personnel box of the document box storage unit 111. Also, in a case where attribute information indicating at least one attribute of the input document indicates [Generation time], and a detail of the attribute information is from “9 a.m. through 12 p.m.,” the document is stored in the before noon box.

Although the table of FIG. 3 only illustrates [Prefix], [Receive time], and [File Size] fields, it will be understood by one of ordinary skill in the art that other storage rules, such as [Generation time], [Generation date], and [Pages] may also be added and easily used.

Referring back to FIG. 2, the user identification information setting unit 211 sets identification information of a user to perform the print job in the image forming apparatus 1. When the user logs in by inputting a user identification (ID) and a password with respect to the image forming apparatus 1 via the user interface unit 23, the user identification information setting unit 211 sets the user identification information according to the input user ID and password. The set user identification information is transmitted to the image forming apparatus 1 via the network interface unit 22. In the present exemplary embodiment, while the user ID and password are used as the user identification information, a type of the user identification information is not limited thereto, and thus any information may be used as long as the information may uniquely indicate or identify a user.

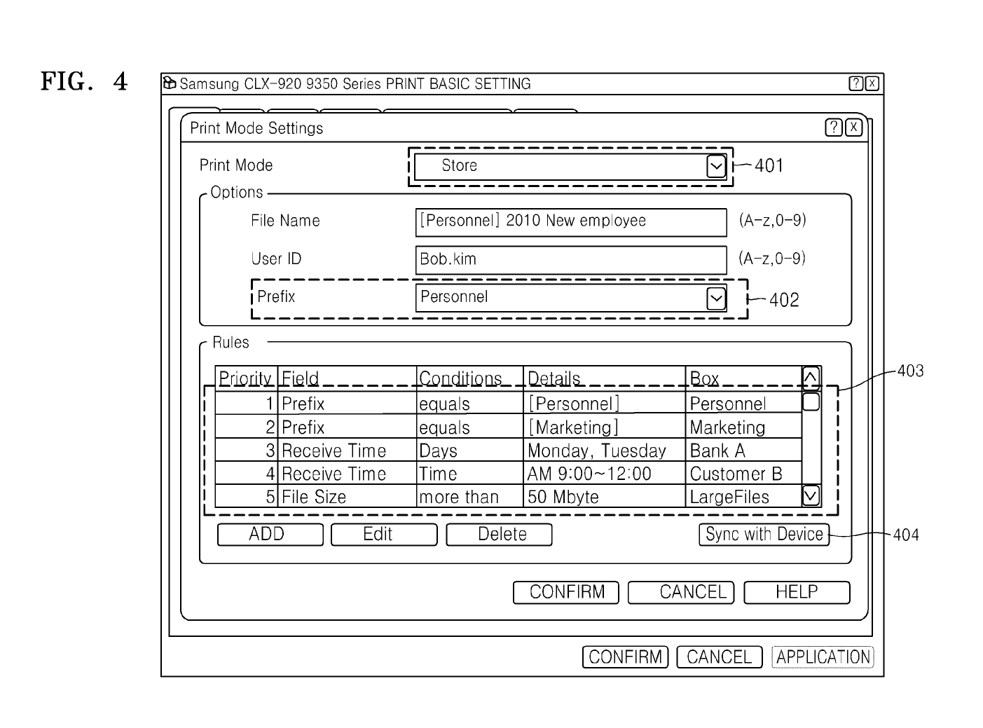

FIG. 4 is a diagram of a case in which information about the store job is input by using a printer driver displayed on a user interface unit 23 according to an exemplary embodiment of the present general inventive concept. Referring to FIG. 4, when a user selects a store job 401 from among the print options, the printer driver 21 that is displayed on the user interface unit 23 receives a file name, a user ID, and a [Prefix] field 402. Here, the printer driver 21 retrieves and displays a storage rule 403 stored in an image forming apparatus 1. In exemplary embodiments, if the user desires to perform a synchronizing operation on the storage rule 403 which is stored in the image forming apparatus 1, the user clicks a synchronization button 404 and performs the synchronizing operation. The user may input attribute information indicating at least one attribute of a document by referring to the storage rule 403 displayed on the printer driver 21. However, if the user is to input new attribute information of the document that is not in the displayed storage rule 403, a procedure to generate a new storage rule may be performed. The procedure to generate the new storage rule will be described later. A print option setting unit 212, an attribute information setting unit 213, and a user identification information setting unit 211 respectively set a print option, information indicating at least one attribute, and user identification information according to information input via the printer driver 21 of FIG. 4.

Referring back to FIG. 2, the network interface unit 22 of the host apparatus 2 communicates with the network interface unit 12 of the image forming apparatus 1 in a wired and/or wireless manner, thereby transmitting information that is input to the host apparatus 2 to the network interface unit 12, or vice versa. To be more specific, the network interface unit 22 transmits information including the print option, a storage condition, or user identification information to the image forming apparatus 1 to the network interface unit 12.

The host controller 24 controls the document to be stored in at least one document box corresponding to the attribute indicated by the attribute information that is input based on the storage rule. The host controller 24 controls operations of the printer driver 21, the network interface unit 22, and the user interface unit 23. Also, when the user interface unit 23 receives a new storage rule, the host controller 24 controls the new storage rule to be added to the storage rule that is previously stored in the image forming apparatus 1, and controls the storage rule to be updated by the new storage rule.

Hereinafter, operations of configuration components of the image forming apparatus 1 will be described.

The network interface unit 12 of the image forming apparatus 1 receives information including a print option, attribute information indicating at least one attribute, and user identification information, and a document from the network interface unit 22 of the host apparatus 2.

The user authentication unit 130 authenticates the user identification information that is input via the network interface unit 12. The user authentication unit 130 authenticates whether the user is a valid user by checking whether the received user identification information is registered. When the received user identification information exists in a list of a plurality of user identification information that is registered in the image forming apparatus 1, the user authentication unit 130 authenticates the received user identification information as that of a valid user. When the user is authenticated as the valid user, the image forming apparatus 1 can perform a storing operation.

The checking unit 131 checks whether at least one attribute indicated by the input attribute information may be applied to the storage rule to store a document in at least one of the document boxes of the image forming apparatus 1 according to attributes of the document. That is, the checking unit 131 checks whether at least one attribute, which is indicated by the attribute information transmitted from the host apparatus 2, may be applied to the storage rule, as illustrated in the table of FIG. 3. In exemplary embodiments, in a case where the user inputs [Prefix] and [Marketing] as a field and condition that correspond to attribute information indicating at least one attribute of the document, the checking unit 131 checks whether [Prefix] and [Marketing] input by the user may be applied to the storage rule, as illustrated in the table of FIG. 3. A result of the checking is transmitted to the document box determining unit 132 so as to be a base by which the document box determining unit 132 determines at least one document box.

The document box determining unit 132 determines at least one document box corresponding to at least one attribute indicated by the attribute information that is input, based on the result of the checking of the checking unit 131. As the result of the checking, if at least one attribute indicated by the input attribute information is applied to the storage rule, the document box determining unit 132 determines at least one document box that is designated by the storage rule. However, if at least one attribute indicated by the input attribute information is not applied to a plurality of conditions included in the storage rule, the document box determining unit 132 determines a default document box. Here, the default document box indicates a common box, of which a title is not limited thereto. When at least one attribute indicated by the input attribute information is applied to the plurality of conditions included in the storage rule, the document box determining unit 132 performs a determining operation according to one of the following examples. However, the present general inventive concept is not limited thereto.

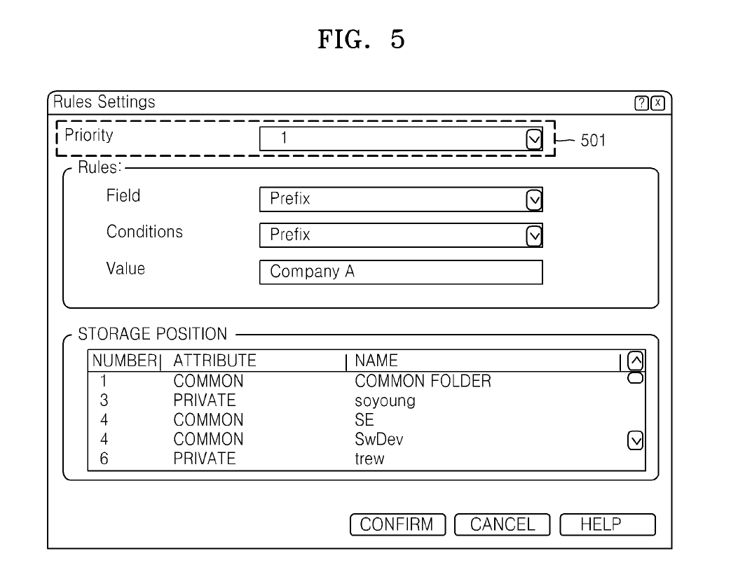

In an exemplary embodiment, a priority order of the plurality of conditions included in the previously stored storage rule is set before the checking of the checking unit 131. Thus, the document box determining unit 132 performs the determining operation according to the priority order that is set. In exemplary embodiments, the priority order of the plurality of conditions is previously set by a user. That is, the document box determining unit 132 determines at least one document box corresponding to a storage rule condition having a highest priority order. The manner in which the priority order is set for each of the conditions included in the storage rule will be described with reference to FIG. 5.

FIG. 5 is a diagram of a case in which a priority order is set for each of the storage conditions included in the storage rule according to an exemplary embodiment of the present general inventive concept. Referring to FIG. 5, when a user defines the storage rule, the user sets a priority order 501 with respect to the storage conditions included in the storage rule. Then, the storage unit 11 may store the storage rule to which the priority order 501 is set. A document box determining unit 132 may perform the determining operation according to the set priority order 501.

In alternative exemplary embodiments, referring back to FIG. 2, the document box determining unit 132 determines all document boxes that correspond to the applied storage conditions. Then, the storage unit 11 may store a copy of the document in all of the determined document boxes. That is, the storage unit 11 may store the document in all of the document boxes which correspond to the storage conditions.

The user may previously perform a setting operation according to a usage environment in such a manner that the document box determining unit 132 determines a document box according to one of the aforementioned first and second examples. However, the present general inventive concept is not limited thereto.

The storage unit 11 stores the document in at least one determined document box. To be more specific, the storage unit 11 may previously store the document box storage unit 111 therein. The stored document box storage unit 111 may include a plurality of document boxes, such as a common box (i.e., a default document box), a marketing box, a personnel box, a forenoon box, or a large capacity box. However, the present general inventive concept is not limited thereto. That is, in alternative exemplary embodiments, the stored document box storage unit 111 may include a secured document box, wherein secured documents may be stored. The document can be stored in at least one document box from the plurality of document boxes. The storage unit 11 stores the storage rule, information transmitted from the host apparatus 2, a result processed in the image forming apparatus 1, or the like, as well as the document box storage unit 111 to store the document.

When the storage unit 11 stores the document in a document box, if another document having a same file name as the document previously stored in the document box, the storage unit 11 may revise the file names of the previously stored document and/or the other document having the same file name, and may store both documents in the document box. For example, in a case where a file name of the document to be stored is ‘2009 Employee Information’, and a document having the same file name already exists, a storage date can be inserted into a file name of each document, and then each document may be stored. That is, when the already stored document is stored on 16 Nov. 2009, and a storage date of the document is 29 Dec. 2009, the storage unit 11 can revise the file name of the previously stored document into ‘2009 Employee Information 20091116’ and then stores the previously stored document, and also may revise a file name of the document into ‘2009 Employee Information 20091229’ and then stores the document. However, it will be understood by one of ordinary skill in the art that a document may be easily revised by inserting a storage time, a storage day, a user name, or the like into a file name, and may be stored.

The control unit 135 controls the document to be stored in at least one determined document box. That is, the control unit 135 controls the document box determining unit 132 and the storage unit 11 so that a store job input from the host apparatus 2 is controlled when performed in the image forming apparatus 1. In addition to this, in order to allow the store job to be normally performed, the control unit 135 may control operations of other configuration components of the image forming apparatus 1.

The user interface unit 14 generates a new document box or when a new storage rule is defined, the user interface unit 14 receives information thereof from a user.

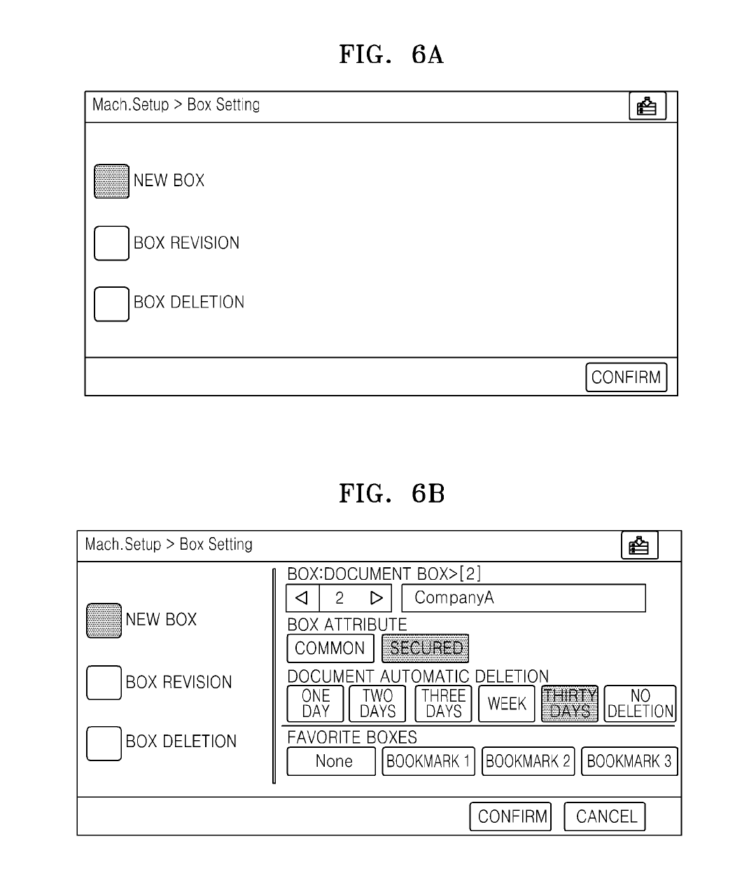

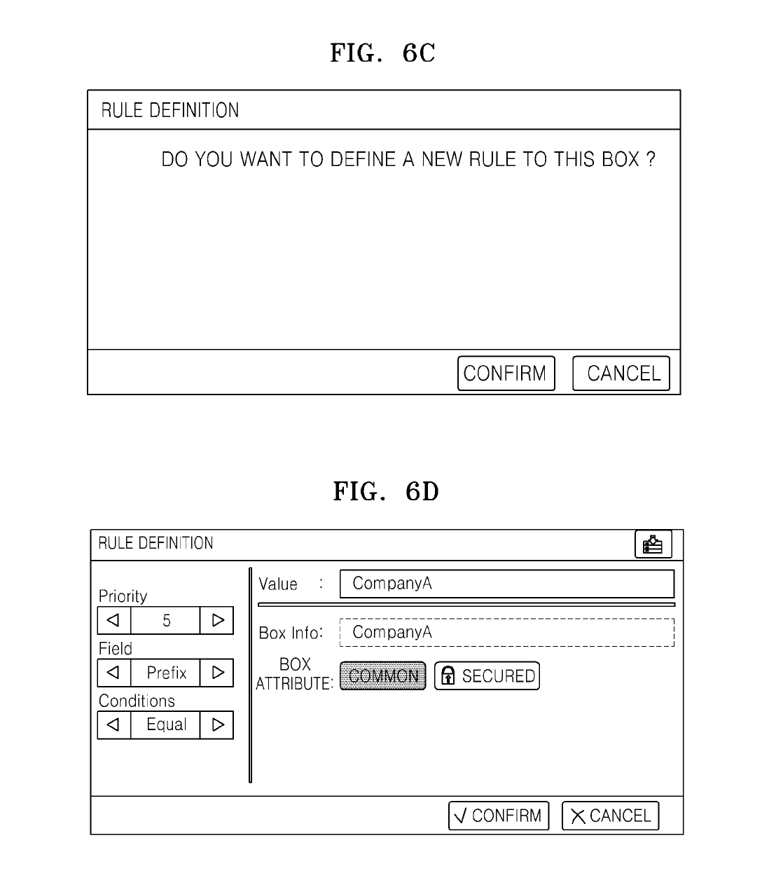

The document box generating unit 133 generates a new document box in the image forming apparatus 1. That is, the document box generating unit 133 determines whether the user inputs a command related to generation of the new document box via the user interface unit 14, and as a result of the determination, if the user has input the command, the document box generating unit 133 generates the document box in the document box storage unit 111. The new document box can be stored in the document box storage unit 111 of the storage unit 11. The generation of the new document box may be performed by the user by using the user interface unit 14 of the image forming apparatus 1 or may also be performed by the user by using the user interface unit 23 of the host apparatus 2. Hereinafter, the generation of the new document box, and a method of setting a new storage rule to the new document box will be described with reference to FIGS. 6A through 6D.

FIGS. 6A through 6D are diagrams of a case in which a document box is newly generated, and a storage rule is defined to the new document box according to an exemplary embodiment of the present general inventive concept. In the case of FIGS. 6A through 6D, the user interface unit 14 of the image forming apparatus 1 of FIG. 2 may be used. However, in alternative exemplary embodiments, as described above, the user interface unit 23 of the host apparatus 2 may also be used.

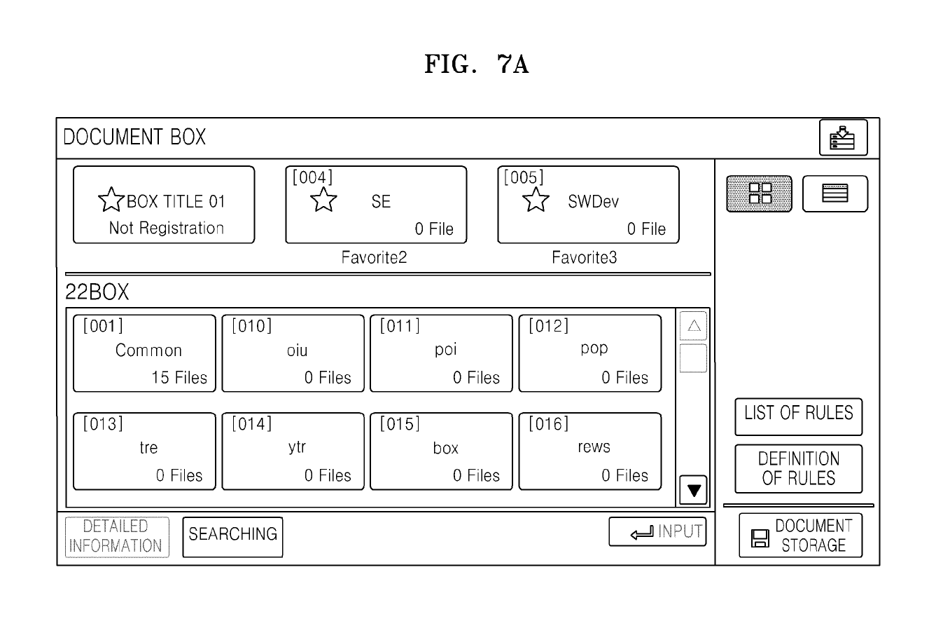

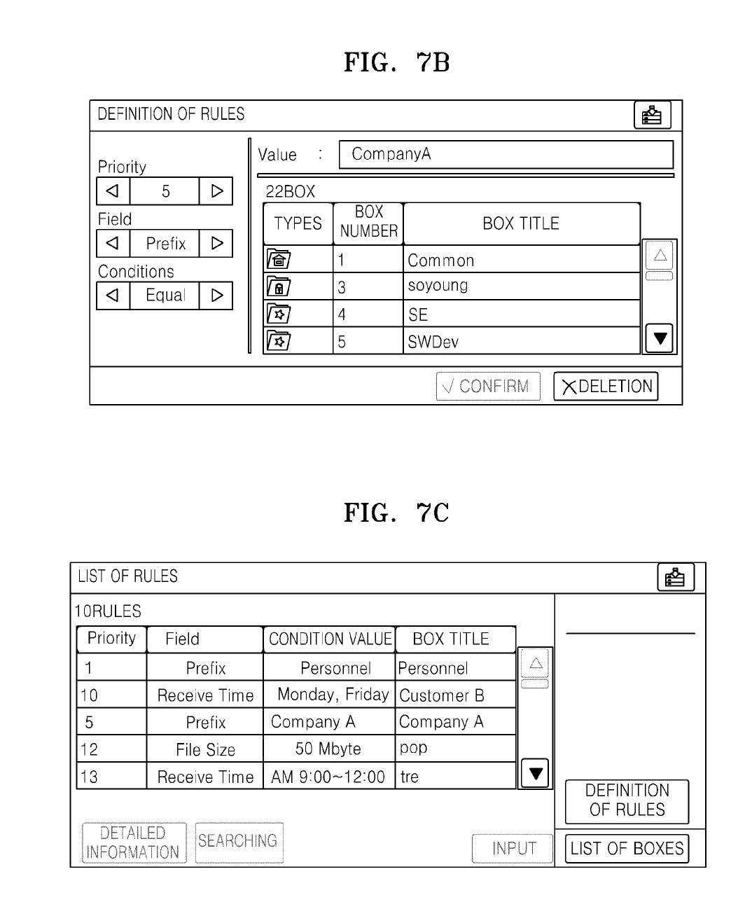

FIG. 6A is a diagram related to setting a document box. Referring to FIG. 6A, the setting of the document box includes menus related to generation of a new document box, revision of an existing document box, and deletion of the existing document box. When a user generates the new document box, the user clicks an icon related to the new document box. Referring to FIG. 6B, the user inputs settings related to the new document box. The user inputs a name, an attribute, a bookmark, and the like regarding the new document box. Referring to FIG. 6C, when settings related to the new document box is complete, the user is queried on whether to designate a storage rule to the new document box. Referring to FIG. 6D, in a case where the user is to define a storage rule with respect to the new document box, the user designates a new storage rule. That is, the user can define the new storage rule with respect to the new document box by inputting a field, definition of conditions, and details included in the storage rule. Referring back to FIG. 2, the user may additionally define a new storage rule with respect to existing document boxes by using the user interface unit 14. A detailed description thereof will be provided with reference to FIGS. 7A through 7C.

FIGS. 7A through 7C are diagrams of a case in which a storage rule is additionally defined in existing document boxes according to an exemplary embodiment of the present general inventive concept.

Referring to FIG. 7A, the user interface unit 14 displays the existing document boxes to a user. The user selects and inputs the document box from among the existing document boxes, wherein a new storage rule may be added to a selected document box. Referring to FIG. 7B, the user may define the storage rule to the selected document box, as described with reference to FIG. 6D. Referring to FIG. 7C, the user interface unit 14 displays a list of the storage rules, including the newly added storage rule, stored in the storage unit 11 (refer to FIG. 2) to the user.

Referring back to FIG. 2, the update unit 134 performs an update operation by adding the input storage rule to the previously stored storage rules, before the checking of the checking unit 131. In a case where the storage rules are updated, the checking unit 131 checks whether at least one attribute indicated by the input attribute information may be applied to the updated storage rules.

The user interface unit 14 displays a result to the user, wherein the result is obtained by storing the document in the determined document box. In addition, the user interface unit 14 displays a result to the user, wherein the result is related to a process performed by the image forming apparatus 1.

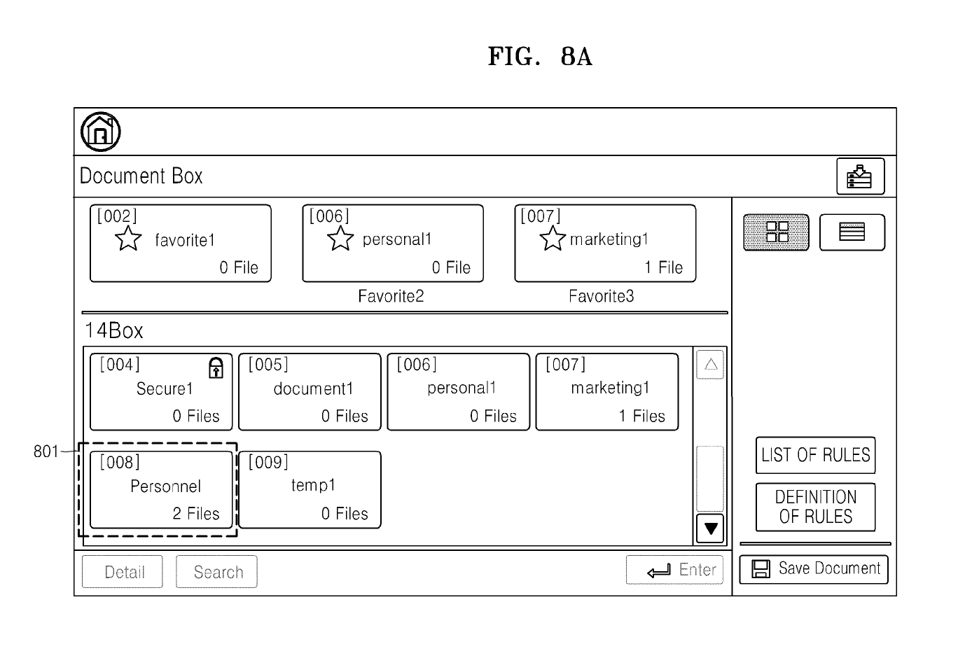

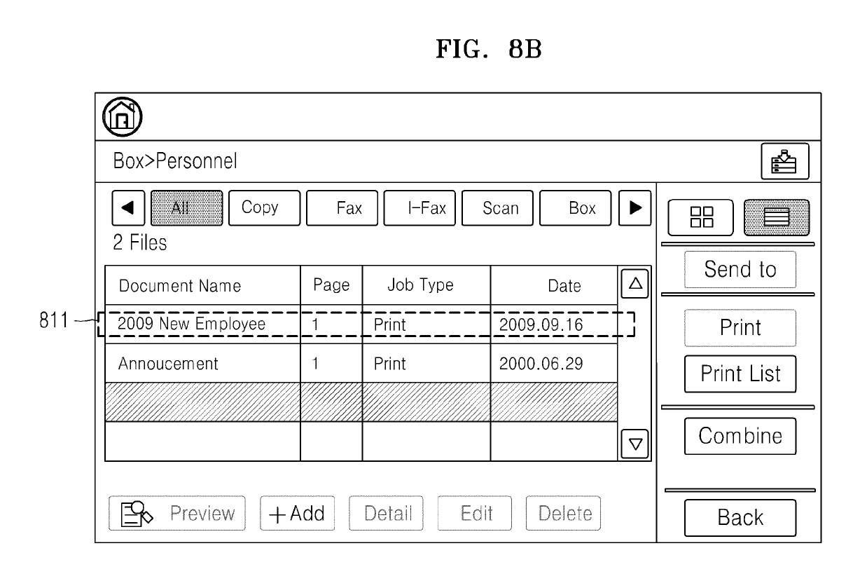

FIGS. 8A and 8B are diagrams of a user interface unit displaying a result obtained by storing a document in a document box 801 according to an exemplary embodiment of the present general inventive concept.

Referring to FIG. 8A, the document box 801 which stores the document is displayed in such a manner that the document box 801 is different from other document boxes. Although not illustrated in FIG. 8A, according to a usage environment, a user may set in such a manner that only the document box 801 which stores the document may be displayed. Referring to FIG. 8B, when the user clicks the document box 801 to store the document, information about the stored document 111 may be displayed.

Referring back to FIG. 2, the image forming unit 15, the facsimile unit 16, and the transmission function performing unit 17 may perform various functions of the image forming apparatus 1 according to the present exemplary embodiment. The image forming unit 15 may perform a printing operation with respect to a document file transmitted from the host apparatus 2. The facsimile unit 16 may perform a fax transmission operation with respect to the document file transmitted from the host apparatus 2. When the network interface unit 12 is connected to a receiving part, the transmission function performing unit 17 transmits the document file transmitted from the host apparatus 2 to a network including a file server, a portable storage medium, or a computer system.

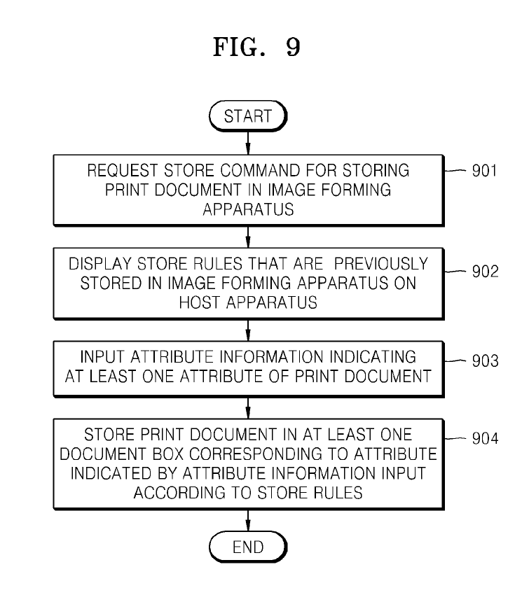

FIG. 9 is a flowchart of a method to store a document in at least one document box stored in an image forming apparatus according to an exemplary embodiment of the present general inventive concept. Referring to FIG. 9, the method to store the document according to the present exemplary embodiment includes operations that are performed in chronological order within the image forming apparatus 1 and the host apparatus 2 of FIG. 2. Thus, although some contents are omitted in the method illustrated in FIG. 9, the aforementioned descriptions related to the image forming apparatus 1 and the host apparatus 2 of FIG. 2 may also be applied to the method to store the document according to the present exemplary embodiment.

In operation 901, the host apparatus 2 may be requested by a user to perform a store job which is a command to store a document in the image forming apparatus 1. The user requests the store job by using a user interface of a printer driver driven in the host apparatus 2, or a user interface of an application program via the user interface unit 23.

In operation 902, the user interface unit 23 displays storage rules that are previously stored in the image forming apparatus 1.

In operation 903, the user interface unit 23 receives attribute information from the user, wherein the attribute information indicates at least one attribute of the document to be stored in the document box.

In operation 904, the host controller 24 controls the document to be stored in the document box corresponding to the at least one attribute indicated by the attribute information of the document input according to the storage rules.

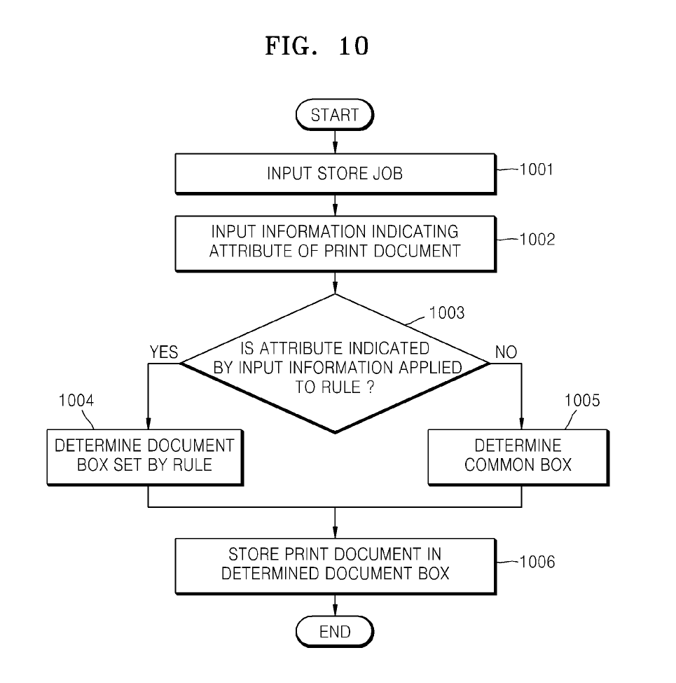

FIG. 10 is a detailed flowchart of the method to store the document of FIG. 9.

In operation 1001, the user interface unit 23 receives the storage job as a print option from the user. The print option setting unit 212 sets the print option input via the user interface unit 23. That is, in a case where the user selects and inputs the store job via the user interface unit 23, the print option setting unit 212 performs a setting operation by which the document is stored in the document box storage unit 111.

In operation 1002, the user interface unit 23 receives the attribute information from the user, wherein the attribute information indicates at least one attribute of the document to be stored in one or more document boxes.

In operation 1003, the checking unit 131 checks whether at least one attribute indicated by the input attribute information may be applied to the storage rules to store the document in one or more document boxes according to attributes of the document. If at least one attribute indicated by the input attribute information is applied to the storage rules, the method proceeds to operation 1004, otherwise, the method proceeds to operation 1005.

In operation 1004, the document box determining unit 132 determines at least one document box defined by the storage rules.

In operation 1005, the document box determining unit 132 determines a common box that is a default document box.

In operation 1006, the storage unit 11 stores the document in the determined at least one document box.

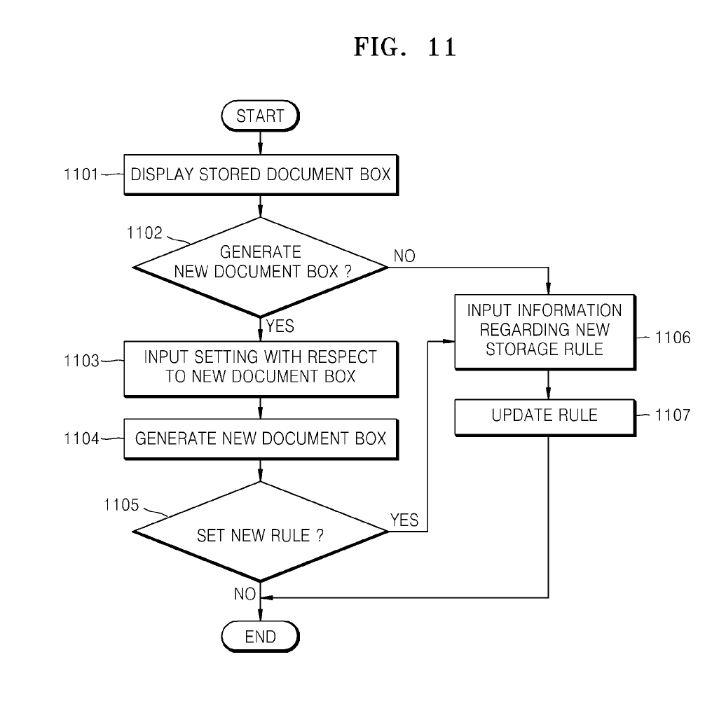

FIG. 11 is a flowchart of a method to set a new storage rule according to an exemplary embodiment of the present general inventive concept. Referring to FIG. 11, the method to set the new storage rule includes operations that are performed in chronological order in the image forming apparatus 1 and the host apparatus 2 of FIG. 2.

In operation 1101, the user interface unit 23 displays document boxes stored in the storage unit 11 to a user.

In operation 1102, the document box generating unit 133 determines whether the user inputs a command related to generation of a new document box via the user interface unit 14. If the user inputs the command related to generation of the new document box, the method proceeds to operation 1103, otherwise, the method proceeds to operation 1106.

In operation 1103, in a case where the user inputs the command related to the generation of the new document box, the user interface unit 14 receives settings related to the new document box from the user.

In operation 1104, the document box generating unit 133 generates the new document box in the document box storage unit 111 according to the input setting.

In operation 1105, the user interface unit 23 displays a query to the user, wherein the query is related to whether to set a new storage rule. If the user sets the new storage rule in the user interface unit 23, the method proceeds to operation 1106.

In operation 1106, the user interface unit 23 receives the setting of the new storage rule from the user.

In operation 1107, the update unit 134 updates the storage rules by adding the new storage rule to the storage rules which were previously stored.

According to the one or more exemplary embodiments of the present general inventive concept, when the store job to store the document in the document box is performed in the image forming apparatus, it is possible to reduce performance issues caused when a host apparatus receives information about document boxes from an image forming apparatus, and a wait time for the document boxes to be displayed on the host apparatus to allow the user to select a document box is not required. Also, the document may be stored in a desired document box according to a previously set storage rule, without being inconvenienced by separately selecting a target-storage document box from among the document boxes.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims and their equivalents. Exemplary embodiments of the present general inventive concept can be embodied as computer programs and can be implemented in general-use digital computers that execute the programs using a computer readable recording medium. In addition, a data structure used in the embodiments of the present general inventive concept can be written in a computer readable recording medium through various means. Examples of the computer readable recording medium include magnetic storage media (e.g., ROM, RAM, floppy disks, hard disks, etc.), optical recording media (e.g., CD-ROMs, Blu-Rays, or DVDs), etc. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

While present general inventive concept has been particularly illustrated and described with reference to exemplary embodiments thereof, it will be understood by those of ordinary skill in the art that various changes in form and details may be made therein without departing from the spirit and scope of the invention as defined by the appended claims and their equivalents. The exemplary embodiments should be considered in a descriptive sense only and not for purposes of limitation. Therefore, the scope of the present general inventive concept may be defined not by the detailed description of the invention but by the appended claims, and all the various differences within the scope will be construed as being included in the present general inventive concept.

What is claimed is:

1. A document storing method of a host apparatus connectable to an image forming apparatus to store a document in at least one document box generated in the image forming apparatus, the document storing method comprising:
receiving a storage command from the host apparatus to store the document in the image forming apparatus;
receiving storage rules stored in the image forming apparatus, and displaying the storage rules on the host apparatus according to the storage command;
receiving attribute information to indicate at least one attribute of the document; and
controlling the document to be stored in at least one document box corresponding to the at least one attribute according to the storage rules.

2. The document storing method of claim 1, wherein the receiving of the storage command comprises receiving the storage command by using a user interface of a printer driver driven by the host apparatus, or by using a user interface of an application program.

3. The document storing method of claim 1, wherein the storage rules comprise a field of the at least one attribute of the document corresponding to the at least one document box, and conditions of the at least one attribute which are defined in the field.

4. The document storing method of claim 1, further comprising receiving the storage rules comprising a field of the at least one attribute of the document corresponding to the at least one document box, and conditions of the at least one attribute which are defined in the field, before receiving the attribute information.

5. The document storing method of claim 1, wherein the controlling comprises performing a control operation according to a result of checking performed in the image forming apparatus, wherein the control operation is related to whether the at least one attribute indicated by the attribute information is applied to the storage rules.

6. The document storing method of claim 5, wherein, when the result of the checking indicates that the at least one attribute indicated by the attribute information is applied to a plurality of conditions comprised in the storage rules, the controlling comprises controlling the document to be copied and then stored in each of a plurality of document boxes corresponding to the plurality of conditions.

7. The document storing method of claim 5, wherein, when the result of the checking indicates that the at least one attribute indicated by the attribute information is not applied to a plurality of conditions comprised in the storage rules, the controlling comprises controlling the document to be stored in a default document box.

8. The document storing method of claim 5, wherein, when the result of the checking indicates that the at least one attribute indicated by the attribute information is applied to a plurality of conditions comprised in the storage rules, the controlling comprises controlling the document to be stored according to a priority order set to the plurality of conditions comprised in the storage rules.

9. The document storing method of claim 1, further comprising controlling a new document box to be generated in the image forming apparatus.

10. The document storing method of claim 1, wherein the attribute information indicates a prefix, a printing time of the document, or a file size of the document.

11. The document storing method of claim 1, further comprising displaying a result obtained by storing the document.

12. A document storing method performed by an image forming apparatus having at least one document box, the document storing method comprising:
when a storage command to store the document in the image forming apparatus is received from a host apparatus, transmitting storage rules stored in the image forming apparatus, and receiving the document and attribute information indicating at least one attribute of the document;
checking whether the at least one attribute indicated by the attribute information is applied to the storage rules;
determining at least one document box corresponding to the at least one attribute indicated by the attribute information according to a result of the checking; and
storing the document in the determined at least one document box.

13. The document storing method of claim 12, further comprising receiving a new storage rule comprising a field of the at least one attribute of the document corresponding to the at least one document box, and conditions of the at least one attribute defined in the field.

14. The document storing method of claim 12, further comprising generating a new document box in the image forming apparatus.

15. A host apparatus connectable to an image forming apparatus to store a document in at least one document box generated in the image forming apparatus, the host apparatus comprising:
a user interface unit to receive a storage command to store the document in the image forming apparatus;
a network interface unit to receive storage rules previously stored in the image forming apparatus according to the storage command;
an attribute information setting unit to receive attribute information indicating at least one attribute of the document via the user interface unit, and setting the attribute information; and
a host controller to control the document to be stored in at least one document box corresponding to the at least one attribute indicated by the attribute information according to the storage rules.

16. The host apparatus of claim 15, wherein the user interface unit receives the storage command by using a printer driver driven in the host apparatus, or an application program.

17. The host apparatus of claim 15, wherein the user interface unit receives a new storage rule comprising a field of the at least one attribute of the document corresponding to the at least one document box, and conditions of the at least one attribute which are defined in the field.

18. An image forming apparatus having at least one document box to store a document, the image forming apparatus comprising:
a network interface unit to receive attribute information indicating at least one attribute of the document;
an checking unit to check whether the at least one attribute indicated by the attribute information is applied to storage rules previously stored in the image forming apparatus;
a document box determining unit to determine at least one document box corresponding to the at least one attribute indicated by the attribute information according to a result of the checking;
a control unit to control the document to be stored in the determined at least one document box; and
a storage unit to store the at least one document box and the storage rules.

19. An image forming apparatus having at least one document box to store a document, the image forming apparatus comprising:
a network interface unit to transmit storage rules previously stored in the image forming apparatus, and to receive the document and attribute information indicating at least one attribute of the document, when a storage command to store the document in the image forming apparatus is received from a host apparatus;
an checking unit to check whether the at least one attribute indicated by the attribute information is applied to the storage rules;
a document box determining unit to determine at least one document box corresponding to the at least one attribute indicated by the attribute information according to a result of the checking; and
a control unit to store the document in the determined at least one document box.

20. The image forming apparatus of claim 19, further comprising an update unit to update the storage rules by adding a new storage rule to the storage rules stored in the image forming apparatus, wherein the new storage rule comprises a field of the at least one attribute of the document corresponding to the at least one document box, and conditions of the at least one attribute defined in the field.

21. An image forming apparatus comprising:
a storage unit to store at least one document box;
a network interface unit to transmit a storage rule to an external device and to receive attribute information of a document when the document is requested to be stored; and
a controller to store the document in the at least one document box according to the
storage rule and the attribute information.

22. The image forming apparatus of claim 21, wherein the document is stored in the at least one document box when the attribute information corresponds with the storage rule.

23. The image forming apparatus of claim 21, further comprising an interface unit to receive the storage rule.

24. A method to store a file in an image forming apparatus, the method comprising:
receiving a first signal to store the file within a plurality of document boxes of an image forming apparatus from a host apparatus;
transmitting a storage rule to the host apparatus;
receiving attribute information of the file; and
controlling the file to be stored within a document box of the plurality of document boxes which corresponds to the attribute information of the file and the storage rule.

25. A document storage method of an image forming apparatus having a plurality of document boxes, the method comprising:
receiving a signal requesting to store a document;
determining whether attribute information of the document corresponds with a storage rule; and
controlling the document to be stored in a first document box when the attribute information corresponds with the storage rule or a second document box when the attribute information does not correspond with the storage rule.

26. The document storage method of claim 25, wherein the storage rule is stored within a storage unit of the image forming apparatus.
